(19) United States
(12) Patent Application Publication
(10) Pub. No.: US 2024/0400402 A1
(43) Pub. Date: Dec. 5, 2024

(54) METHOD FOR PRODUCING AMMONIA, AND MOLYBDENUM COMPLEX USED IN PRODUCTION METHOD AND LIGAND THAT IS RAW MATERIAL FOR MOLYBDENUM COMPLEX

(71) Applicants: THE UNIVERSITY OF TOKYO, Tokyo (JP); NISSAN CHEMICAL CORPORATION, Tokyo (JP); IDEMITSU KOSAN CO., LTD., Tokyo (JP)

(72) Inventors: Yoshiaki NISHIBAYASHI, Tokyo (JP); Kazuya ARASHIBA, Tokyo (JP); Taichi MITSUMOTO, Tokyo (JP); Shoichi KONDO, Funabashi-shi (JP); Norihito SHIGA, Funabashi-shi (JP); Yuki SHINOHARA, Sodegaura-shi (JP); Norio TOMOTSU, Sodegaura-shi (JP)

(73) Assignees: THE UNIVERSITY OF TOKYO, Tokyo (JP); NISSAN CHEMICAL CORPORATION, Tokyo (JP); IDEMITSU KOSAN CO., LTD., Tokyo (JP)

(21) Appl. No.: 18/688,865

(22) PCT Filed: Sep. 6, 2022
(86) PCT No.: PCT/JP2022/033436

§ 371 Date: Mar. 4, 2024

(30) Foreign Application Priority Data
Sep. 6, 2021 (JP) 2021-144978

(51) Int. Cl. C01C 1/04; B01J 31/24

(52) U.S. Cl. CPC C01C 1/04; B01J 31/24; B01J 2531/64

(57) ABSTRACT

A method for producing ammonia from nitrogen molecules with a reducing agent and a proton source, the method using, as a catalyst, a molybdenum complex obtained by reacting a ligand of Formula (1) and a molybdenum compound:

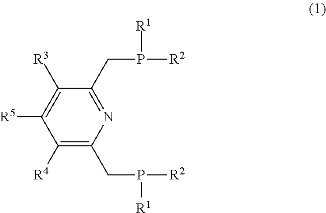

wherein R¹ and R² are each independently C₃₋₁₀ alkyl group, R³, R⁴ and R⁵ are each independently a hydrogen atom, a fluorine atom, a trifluoromethyl group, a phenyl group, or an Ar¹ aryl group, and at least one of R³, R⁴ and R⁵ is a phenyl group or an Ar¹ aryl group, a molybdenum complex used in the method and a ligand that is a raw material for the molybdenum.

### TECHNICAL FIELD

The present invention relates to a method for producing ammonia, and a molybdenum complex used in the production method and a ligand that is a raw material for the molybdenum complex.

### BACKGROUND ART

The Haber-Bosch process, which is an industrial method for converting nitrogen molecules into ammonia, is an energy-intensive process that requires harsh conditions of a high temperature and high pressure, and also consumes energy to produce hydrogen gas. Therefore, a few percent of the world's annual energy consumption is used in the Haber-Bosch process. On the other hand, in recent years, in a method for producing ammonia from nitrogen molecules without using hydrogen gas under atmospheric pressure at room temperature, there has been a reported case regarding production of ammonia using a molybdenum complex as a catalyst and water as a proton source (Non-Patent Document 1). In addition, there is a report example regarding production of ammonia using: a molybdenum complex as a catalyst; samarium(II) iodide as a reducing agent; and alcohols or water as a proton source (Non-Patent Document 2). Non-Patent Document 2 discloses, for example, molybdenum complexes of Formula (A) and Formula (B),

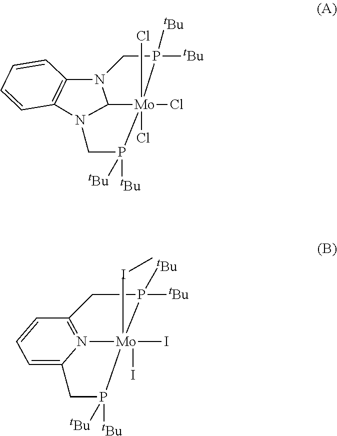

and these molybdenum complexes have a phosphorus-carbon-phosphorus type pincer ligand (hereinafter referred to as a PCP ligand) and a phosphorus-nitrogen-phosphorus type pincer ligand (hereinafter referred to as a PNP ligand) in which three coordinating atoms are bonded in three directions on the same plane including molybdenum metal.

### PRIOR ART DOCUMENTS

### Non-Patent Documents

Non-Patent Document 1: The 99th Spring Annual Meeting of The Chemical Society of Japan, 2019, Lecture number 4D1-37
Non-Patent Document 2: Nature 2019, vol. 568 (7753), pp. 536-540

### SUMMARY OF THE INVENTION

### Problem to be Solved by the Invention

As ligands around the molybdenum metal, regarding molybdenum complexes with ligands different from convention, the development of highly versatile molybdenum complexes, which make it possible to produce ammonia and can be used for industrialization, has been expected.

### Means for Solving the Problem

In order to achieve the above object, the inventors have conducted molecular designing and investigation of a molybdenum complex having a phosphorus-nitrogen-phosphorus type pincer ligand (PNP ligand), and found that, when a phenyl group or an aryl group with an electron-attracting substituent is introduced into a ligand of the molybdenum complex, the molybdenum complex functions as a catalyst for production of ammonia, exceeding the performance of previously known molybdenum complexes having a PNP ligand. The present invention has been thus completed.

Specifically, the present invention provides:
[1] A method for producing ammonia from nitrogen molecules in the presence of a reducing agent and a proton source using, as a catalyst, a molybdenum complex obtained by reacting a ligand of Formula (1) and a molybdenum compound:

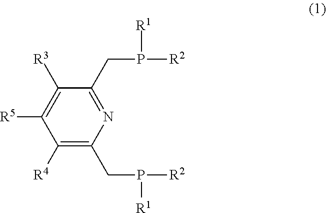

(wherein R¹ and R² are each independently C₃₋₁₀ alkyl group, R³, R⁴ and R⁵ are each independently a hydrogen atom, a fluorine atom, a trifluoromethyl group, a phenyl group, or an Ar¹ aryl group, and at least one of R³, R⁴ and R⁵ is a phenyl group or an Ar¹ aryl group).
[2] A method for producing ammonia from nitrogen molecules in the presence of a reducing agent and a proton source using, as a catalyst, a molybdenum complex of Formula (2):

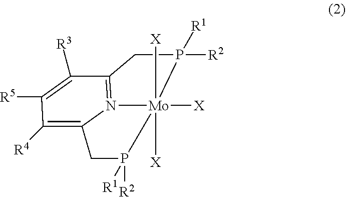

(wherein R¹, R², R³, R⁴, and R⁵ are the same as defined above, and X is a halogen atom).
[3] The method for producing ammonia according to [1] or [2],
   wherein an energy level of a highest occupied orbital of the reducing agent is −5.0 eV or more, that is, an ionization potential is 5.0 eV or less.
[4] The method for producing ammonia according to [1] or [2],
   wherein the reducing agent is a lanthanoid metal halide or a sandwich compound.
[5] The method for producing ammonia according to any one of [1] to [4],
   wherein the proton source is an alcohol or water.
[6] A ligand of Formula (1):

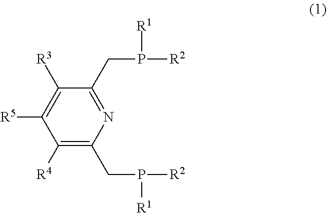

(wherein R¹ and R² are each independently C₃₋₁₀ alkyl group, R³ and R⁴ are each independently a hydrogen atom, a fluorine atom, a trifluoromethyl group, a phenyl group, or an Ar¹ aryl group, and R⁵ is an Ar¹ aryl group).
[7] A molybdenum complex of Formula (2):

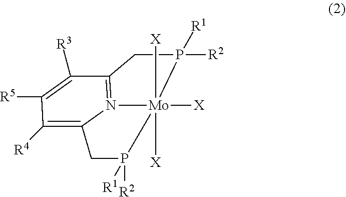

(wherein R¹ and R² are each independently C₃₋₁₀ alkyl group, R³ and R⁴ are each independently a hydrogen atom, a fluorine atom, a trifluoromethyl group, a phenyl group, or an Ar¹ aryl group, and R⁵ is an Ar¹ aryl group).

### Effects of the Invention

There is provided a new method in which it is possible to produce ammonia using a molybdenum complex having a PNP ligand of the present invention.

### MODES FOR CARRYING OUT THE INVENTION

In this specification, “n” is an abbreviation for normal, “s” is an abbreviation for secondary, “t” is an abbreviation for tertiary, “o” is an abbreviation for ortho, “m” is an abbreviation for meta, and “p” is an abbreviation for para. “Bu” is an abbreviation for a tertiary butyl group, and “thf” is an abbreviation for tetrahydrofuran.

In this specification, C_{a-b} alkyl group is a monovalent group formed by removing one hydrogen atom from linear, branched or cyclic aliphatic hydrocarbon having a carbon atom number of a to b, and specific examples thereof include methyl group, ethyl group, n-propyl group, isopropyl group, cyclopropyl group, n-butyl group, isobutyl group, s-butyl group, t-butyl group, cyclobutyl group, n-pentyl group, isopentyl group, neopentyl group, t-pentyl group, 1,1-dimethylpropyl group, cyclopentyl group, n-hexyl group, isohexyl group, 3-methylpentyl group, 2,2-dimethylbutyl group, 2,3-dimethylbutyl group, cyclohexyl group, n-heptyl group, 2-methylhexyl group, 3-ethylpentyl group, n-octyl group, 2,2,4-trimethylpentyl group, 2,5-dimethylhexyl group, n-nonyl group, 2,7-dimethyloctyl group, n-decyl group, adamantyl group, n-undecyl group, 1-methylundecyl group, and n-dodecyl group, and those are set based on the number of carbon atoms within each designated range. In “C_{a-b}” indicating the number of carbon atoms, a is an integer of 1 or more, and b is an integer of a or more.

In this specification, specific examples of halogen atoms include a fluorine atom, a chlorine atom, a bromine atom, and an iodine atom.

In this specification, the Ar¹ aryl group is a monovalent group obtained by removing one hydrogen atom from an aromatic ring of C₆ aromatic hydrocarbon, and for example, is a phenyl group having at least one substituent at the positions 2 to 6. Examples of substituents on the aromatic ring of the Ar¹ aryl group include electron-attracting groups, and although the mesomeric effect of electron-attracting groups is electron-donating, examples of substituents that have a large contribution to electron-attracting inductive effects include a fluorine atom, chlorine atom, bromine atom, iodine atom, and —CH═CHNO₂, and examples of substituents whose mesomeric effect and inductive effect are electron-attracting include trifluoromethyl group, trichloromethyl group, cyano group, nitro group, formyl group, and carboxylic acid group, and preferable examples of electron-attracting groups include a fluorine atom and trifluoromethyl group.

Examples of Ar¹ aryl groups include o-fluorophenyl group, m-fluorophenyl group, p-fluorophenyl group, 2,6-difluorophenyl group, 3,5-difluorophenyl group, 3,4,5-trifluorophenyl group, 2,3,4,5,6-pentafluorophenyl group, o-trifluoromethylphenyl group, m-trifluoromethylphenyl group, p-trifluoromethylphenyl group, or 3,5-bis(trifluoromethyl)phenyl group.

R¹ and R² in Formula (1) and Formula (2) will be described. R¹ and R² are each independently C₃₋₁₀ alkyl group, preferably isopropyl group, cyclopropyl group, isobutyl group, s-butyl group, t-butyl group, cyclobutyl group, isopentyl group, neopentyl group, t-pentyl group, 1,1-dimethylpropyl group, cyclopentyl group, isohexyl group, 3-methylpentyl group, 2,2-dimethylbutyl group, 2,3-dimethylbutyl group, cyclohexyl group, and adamantyl group, and more preferably isopropyl group, t-butyl group, and adamantyl group.

R³ and R⁴ in Formula (1) and Formula (2) will be described. R³ and R⁴ are each independently a hydrogen atom, a fluorine atom, trifluoromethyl group, a phenyl group, or an Ar¹ aryl group. Specific examples of Ar¹ aryl groups include o-fluorophenyl group, m-fluorophenyl group, p-fluorophenyl group, 2,6-difluorophenyl group, 3,5-difluorophenyl group, 3,4,5-trifluorophenyl group, 2,3,4,5,6-pentafluorophenyl group, o-trifluoromethylphenyl group, m-trifluoromethylphenyl group, p-trifluoromethylphenyl group, or 3,5-bis(trifluoromethyl)phenyl group.

R³ and R⁴ in Formula (1) and Formula (2) are preferably a hydrogen atom, a phenyl group, o-fluorophenyl group, m-fluorophenyl group, p-fluorophenyl group, 2,6-difluorophenyl group, 3,5-difluorophenyl group, 3,4,5-trifluorophenyl group, 2,3,4,5,6-pentafluorophenyl group, o-trifluoromethylphenyl group, m-trifluoromethylphenyl group, p-trifluoromethylphenyl group, and 3,5-bis(trifluoromethyl)phenyl group, and particularly preferably a hydrogen atom.

R⁵ in Formula (1) and Formula (2) will be described. Examples of R⁵ include an Ar¹ aryl group, and specific examples of substituents on the aromatic ring of the Ar¹ aryl group, and Ar¹ aryl groups are the same as above.

More specific examples of R⁵ in Formula (1) and Formula (2) include o-fluorophenyl group, m-fluorophenyl group, p-fluorophenyl group, 2,6-difluorophenyl group, 3,5-difluorophenyl group, 3,4,5-trifluorophenyl group, 2,3,4,5,6-pentafluorophenyl group, o-trifluoromethylphenyl group, m-trifluoromethylphenyl group, p-trifluoromethylphenyl group, or 3,5-bis(trifluoromethyl)phenyl group, and preferable examples thereof include m-fluorophenyl group, p-fluorophenyl group, 3,5-difluorophenyl group, 3,4,5-trifluorophenyl group, o-trifluoromethylphenyl group, m-trifluoromethylphenyl group, p-trifluoromethylphenyl group, and 3,5-bis(trifluoromethyl)phenyl group.

In the method for producing ammonia of the present embodiment, R¹, R², R³ and R⁴ in Formula (1) and Formula (2) are the same as above, examples of R⁵ in Formula (1) and Formula (2) include a phenyl group and an Ar¹ aryl group, specific examples thereof include a phenyl group, o-fluorophenyl group, m-fluorophenyl group, p-fluorophenyl group, 2,6-difluorophenyl group, 3,5-difluorophenyl group, 3,4,5-trifluorophenyl group, 2,3,4,5,6-pentafluorophenyl group, o-trifluoromethylphenyl group, m-trifluoromethylphenyl group, p-trifluoromethylphenyl group, and 3,5-bis(trifluoromethyl)phenyl group, and preferable examples thereof include a phenyl group, m-fluorophenyl group, p-fluorophenyl group, 3,5-difluorophenyl group, 3,4,5-trifluorophenyl group, o-trifluoromethylphenyl group, m-trifluoromethylphenyl group, p-trifluoromethylphenyl group, and 3,5-bis(trifluoromethyl)phenyl group.

X in the molybdenum complex of Formula (2) will be described. Examples of X include a halogen atom, X is preferably an iodine atom, bromine atom, or chlorine atom, and X is more preferably an iodine atom or chlorine atom.

The molybdenum compound used when the molybdenum complex of Formula (2) is synthesized will be described. Examples of molybdenum compounds include molybdenum(III) chloride, molybdenum(III) bromide, molybdenum(III) iodide, trichlorotris(tetrahydrofuran)molybdenum(III), tribromotris(tetrahydrofuran)molybdenum(III), and triiodotris(tetrahydrofuran)molybdenum(III), and preferable molybdenum compounds include trichlorotris(tetrahydrofuran)molybdenum(III) and triiodotris(tetrahydrofuran)molybdenum(III).

In the method for producing ammonia of the present embodiment, when X in the molybdenum complex of Formula (2) is prepared with a bromine atom or a chlorine atom, a halogen exchange reaction of a ligand is performed by adding iodine or a reducing agent containing iodine in a reaction system for producing ammonia, and X in the molybdenum complex of Formula (2) is able to generate a complex of an iodine atom in the reaction system. Thus, the amount and rate of ammonia production in the complex can be increased.

In the method for producing ammonia of the present embodiment, examples of reducing agents include those in which the energy level of the highest occupied orbital of the reducing agent is −5.0 eV or more, that is, the ionization potential is 5.0 eV or less.

In the method for producing ammonia of the present embodiment, examples of reducing agents include lanthanoid metal halides or sandwich compounds.

Examples of lanthanoid metals of lanthanoid metal halides include lanthanum, cerium, praseodymium, neodymium, promethium, samarium, europium, gadolinium, terbium, dysprosium, holmium, erbium, thulium, ytterbium and lutetium, and among these, samarium, europium and ytterbium, which can also be in a divalent state, are preferable, and examples of halogens of lanthanoid metal halides include chlorine, bromine, and iodine, and iodine is preferable.

The lanthanoid metal halide may be a complex coordinated with an ether compound such as tetrahydrofuran, 4-methyltetrahydropyran, diethyl ether or the like, and when ammonia is produced in a solvent, for example, a complex in which tetrahydrofuran is coordinated with a lanthanoid metal halide can also be used. Commercially available lanthanoid metal halides, for example, EuCl₂, EuI₂, SmI₂ and YbI₂, are commercially available from Sigma-Aldrich Japan.

Examples of preferable lanthanoid metal halides include samarium(II) halide, europium(II) halide, ytterbium(II) halide, and complexes in which tetrahydrofuran is coordinated with the above compounds, and samarium(II) iodide and a complex of samarium(II) iodide coordinated with tetrahydrofuran (for example, SmI₂(thf)₂, which can be obtained by dissolving SmI₂ in tetrahydrofuran and recrystallizing it) are more preferable.

The sandwich compound is a compound composed of metal atoms and two arene ligands, and examples of metal atoms of the sandwich compound include titanium, zirconium, hafnium, vanadium, niobium, tantalum, molybdenum, tungsten, iron, ruthenium, cobalt, rhodium, iridium, nickel, palladium, platinum, and samarium, and chromium, molybdenum, tungsten, iron, ruthenium, cobalt, rhodium and iridium are preferable.

In addition, examples of sandwich compounds composed of the metal atoms and two arene ligands include a bis(cyclopentadienyl) metal complex, a bis(pentamethylcyclopentadienyl) metal complex, a bis(benzene) metal complex, and a bis(cyclooctatetraenyl) metal complex, a bis(cyclopentadienyl) metal complex and a bis(pentamethylcyclopentadienyl) metal complex are preferable, and in consideration of complex stability and suppression of side reactions, a bis(pentamethylcyclopentadienyl) metal complex is more preferable.

Among these sandwich compounds composed of metal atoms and two arene ligands, preferable examples include bis(η⁵-pentamethylcyclopentadienyl)cobalt(II), and bis(η⁵-pentamethylcyclopentadienyl)chromium(II).

In the method for producing ammonia of the present embodiment, ammonia may be produced in a solvent using nitrogen molecules as a raw material. The solvent is not particularly limited as long as it can dissolve or disperse the reducing agent, and examples thereof include cyclic ether compounds, chain ether compounds, nitrile compounds, aromatic hydrocarbon compounds, or saturated hydrocarbon compounds. Examples of cyclic ether compounds include tetrahydrofuran, 4-methyltetrahydropyran, tetrahydropyran-4-methanol or 1,4-dioxane. Examples of chain ether compounds include diethyl ether, diisopropyl ether, 1,2-dimethoxyethane, or cyclopentyl methyl ether. Examples of nitrile compounds include acetonitrile or propionitrile. Examples of aromatic hydrocarbon compounds include toluene or o-xylene. Examples of saturated hydrocarbon compounds include hexane, heptane, or petroleum ether. In the method for producing ammonia of the present embodiment, preferable solvents include tetrahydrofuran and 1,2-dimethoxyethane.

In the method for producing ammonia of the present embodiment, examples of proton sources include an alcohol or water. As the alcohol used, glycol and R^{a}OH (R^{a} is a chain alkyl group, cyclic alkyl group, or branched alkyl group having a carbon atom number of 1 to 6 in which a hydrogen atom may be substituted with a fluorine atom) may be used.

Examples of glycols include ethylene glycol, propylene glycol or diethylene glycol.

R^{a}OH is, for example, a chain or branched alkyl alcohol, such as methanol, ethanol, propanol, isopropanol, n-butyl alcohol, s-butyl alcohol, isobutyl alcohol or t-butyl alcohol, and examples of cyclic alkyl alcohols include cyclopropanol, cyclopentanol or cyclohexanol.

Examples of alcohols containing fluorine atoms include trifluoroethyl alcohol or tetrafluoroethyl alcohol.

In the method for producing ammonia of the present embodiment, preferable proton sources include water and ethylene glycol, and water is more preferable.

The yield of generated ammonia can be measured by a known method. Fixed quantity of ammonia in a sulfuric acid solution can be defined using, for example, a known indophenol method (Analytical Chemistry, 1967, vol. 39, pp. 971-974).

In the method for producing ammonia of the present embodiment, as the nitrogen molecules, nitrogen gas at atmospheric pressure or at pressurized pressure can be used, and it is preferable to use nitrogen gas at atmospheric pressure. Since nitrogen gas is inexpensive, it may be used in a large excess relative to other reagents.

In the method for producing ammonia of the present embodiment, the reaction temperature is not particularly limited as long as the reaction proceeds, and is preferably −10° C. to 60° C. and more preferably 0° C. to 50° C.

In the method for producing ammonia of the present embodiment, the amount of the catalyst used with respect to the reducing agent is preferably 0.00001 equivalents to 0.1 equivalents and more preferably 0.0001 equivalents to 0.01 equivalents. The amount of the proton source used with respect to the reducing agent is preferably 0.5 equivalents to 5 equivalents and more preferably 1 equivalent to 2 equivalents.

Here, the present invention is not limited to the above embodiments, and can be implemented in various forms within the technical scope of the present invention.

### EXAMPLES

Hereinafter, examples of the present invention will be described. Here, the following examples do not limit the present invention.

### [Synthesis Example 1] Synthesis of Compound of Formula (5a)

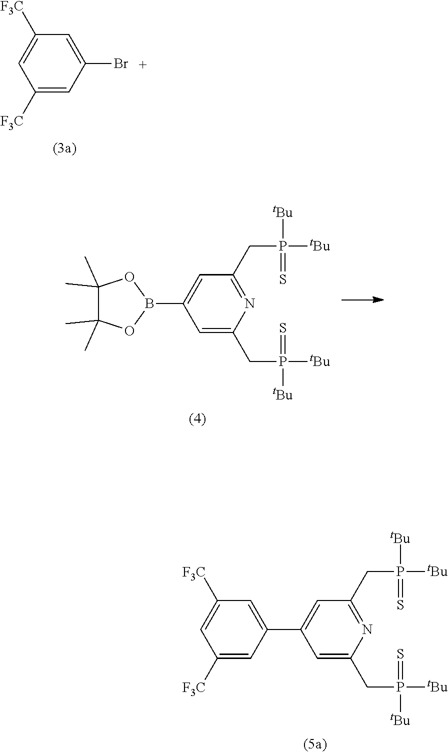 [SMILES: FC(F)(F)c1cc(Br)cc(C(F)(F)F)c1 ; CC1(C)OB(c2cc(CP(=S)(C(C)(C)C)C(C)(C)C)nc(CP(=S)(C(C)(C)C)C(C)(C)C)c2)OC1(C)C ; CC(C)(C)P(=S)(Cc1cc(-c2cc(C(F)(F)F)cc(C(F)(F)F)c2)cc(CP(=S)(C(C)(C)C)C(C)(C)C)n1)C(C)(C)C]

Under a nitrogen atmosphere, 1-bromo-3,5-bis(trifluoromethyl)benzene of Formula (3a) (498 mg, 1.70 mmol, commercially available from Tokyo Chemical Industry Co., Ltd.), 2,6-bis[[bis(1,1-dimethylethyl)phosphinothioyl]methyl]-4-(4,4,5,5-tetramethyl-1,3,2-dioxaborolane-2-yl)pyridine of Formula (4) (1.20 g, 2.05 mmol, can be synthesized by the method described in Non-Patent Document, Journal of the American Chemical Society 2014, vol. 136(27), pp. 9719-9731), potassium carbonate (1.18 g, 8.54 mmol, commercially available from Tokyo Chemical Industry Co., Ltd.) and tetrakis(triphenylphosphine)palladium(0) (196 mg, 0.17 mmol, commercially available from Tokyo Chemical Industry Co., Ltd.) were put into to a reaction container, and toluene (30 mL, commercially available from FUJIFILM Wako Pure Chemical Corporation) was then put into the reaction container, and the mixture was stirred at 90° C. for 48 hours.

Then, the reaction mixture was cooled to 20° C. to 25° C. to stop the reaction, and the reaction mixture was concentrated under a reduced pressure. Water was added to the obtained residue, extraction with ethyl acetate was performed, the organic layer was washed with water and saturated saline, and concentration was performed under a reduced pressure. The obtained crude product was purified through silica gel column chromatography (hexane:ethyl acetate=1:9 (volume ratio)) to obtain a title compound (812 mg, 1.21 mmol, yield 71%) as a transparent solid. Data of the obtained title compound is described below.

¹H NMR (CDCl₃):

δ 8.17 (s, 2H), 8.02 (s, 2H), 7.19 (s, 1H), 3.56 (d, J=11.2 Hz, 4H), 1.35 (d, J=14.8 Hz, 36H).

³¹P NMR (CDCl₃):

δ 78.3 (s).

Anal. Calcd. for C₃₁H₄₅F₆NP₂S₂:

C, 55.43; H, 6.75; N, 2.09.

Found:

C, 55.51; H, 6.91; N, 1.91.

### [Synthesis Example 2] Synthesis of Compound of Formula (6a)

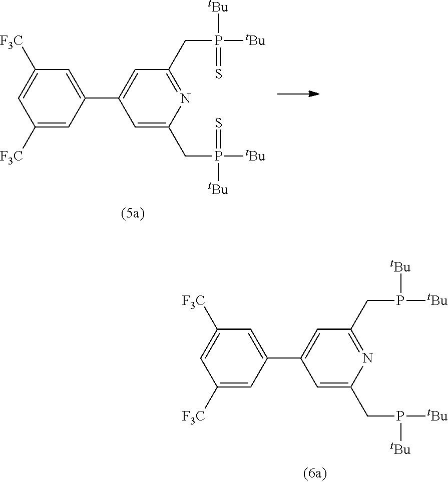 [SMILES: CC(C)(C)P(=S)(Cc1cc(-c2cc(C(F)(F)F)cc(C(F)(F)F)c2)cc(CP(=S)(C(C)(C)C)C(C)(C)C)n1)C(C)(C)C ; CC(C)(C)P(Cc1cc(-c2cc(C(F)(F)F)cc(C(F)(F)F)c2)cc(CP(C(C)(C)C)C(C)(C)C)n1)C(C)(C)C]

Under a nitrogen atmosphere, 2,6-bis[[bis(1,1-dimethylethyl)phosphinothioyl]methyl]-4-[3,5-bis(trifluoromethyl)phenyl]pyridine of Formula (5a) (136 mg, 0.202 mmol) and dichloromethane (6.50 mL, commercially available from Kanto Chemical Co., Inc.) were put into a reaction container, and methyl trifluoromethanesulfonate (44 μL, 0.40 mmol, commercially available from Tokyo Chemical Industry Co., Ltd.) was then added, and the mixture was stirred at a room temperature of 20° C. to 25° C. for 28 hours and tris(dimethylamino)phosphine (73 ILL, 0.40 mmol, commercially available from Tokyo Chemical Industry Co., Ltd.) was then added, and the mixture was stirred at room temperature of 20° C. to 25° C. for 2 hours.

Then, the reaction mixture was concentrated under a reduced pressure. Water was added to the obtained residue, extraction with diethyl ether was performed, the organic layer was washed with water and saturated saline, and concentration was performed under a reduced pressure to obtain a title compound (118 mg, 0.194 mmol, yield 96%) as a yellowish white solid. Data of the obtained title compound is described below.

¹H NMR (CDCl₃):

δ 7.82 (s, 2H), 7.67 (s, 1H), 7.44 (s, 1H), 3.18 (d, J=2.8 Hz, 4H), 1.14 (d, J=10.8 Hz, 36H).

³¹P{¹H} NMR (CDCl₃):

δ 36.64 (s).

### [Synthesis Example 3] Synthesis of Molybdenum Complex of Formula (7a)

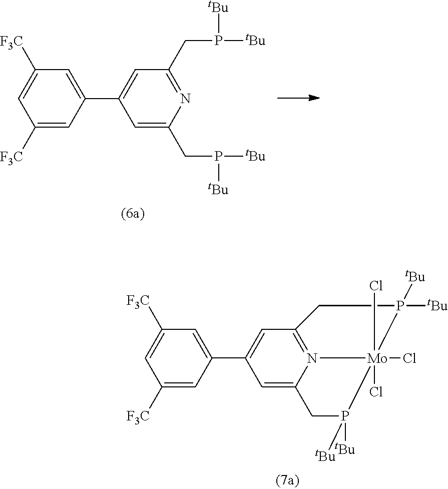

Under a nitrogen atmosphere, 2,6-bis[[bis(1,1-dimethylethyl)phosphino]methyl]-4-[3,5-bis(trifluoromethyl)phenyl]pyri dine of Formula (6a) (118 mg, 0.194 mmol), triiodotris(tetrahydrofuran)molybdenum(III) (69.4 mg, 0.166 μmol) and tetrahydrofuran (6 mL, commercially available from Kanto Chemical Co., Inc.) were put into a reaction container and the mixture was then stirred at 50° C. for 12 hours.

Then, the reaction mixture was concentrated and then recrystallized in a two-layer system including dichloromethane:hexane=1:4 (volume ratio) to obtain a title molybdenum complex (102 mg, 0.126 mmol, yield 76%) as a red solid. Data of the obtained molybdenum complex is described below.

Anal. Calcd. for [molybdenum complex of Formula (7a)/0.5 dichloromethane]:

C, 43.59; H, 5.52; N, 1.67.

Found:

C, 43.57; H, 5.76; N, 1.82.

### [Synthesis Example 4] Synthesis of Compound of Formula (5b)

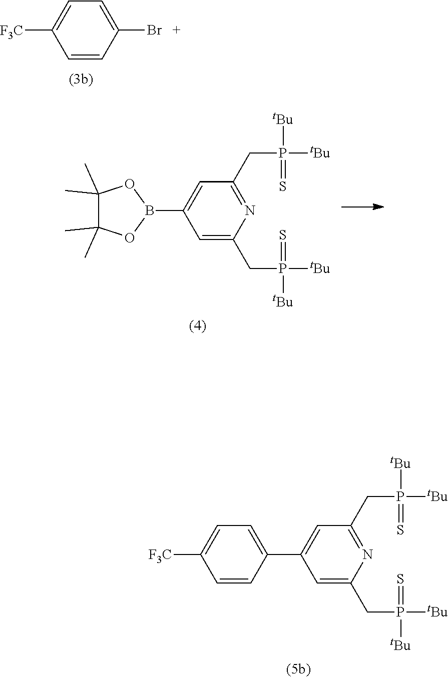 [SMILES: FC(F)(F)c1ccc(Br)cc1 ; CC1(C)OB(c2cc(CP(=S)(C(C)(C)C)C(C)(C)C)nc(CP(=S)(C(C)(C)C)C(C)(C)C)c2)OC1(C)C ; CC(C)(C)P(=S)(Cc1cc(-c2ccc(C(F)(F)F)cc2)cc(CP(=S)(C(C)(C)C)C(C)(C)C)n1)C(C)(C)C]

Synthesis was performed according to the description in Synthesis Example 1 in this specification using 1-bromo-4-(trifluoromethyl)benzene of Formula (3b) (commercially available from FUJIFILM Wako Pure Chemical Corporation) in place of 1-bromo-3,5-bis(trifluoromethyl)benzene of Formula (3a) used in Synthesis Example 1 to obtain a title compound (742 mg, 1.23 mmol, yield 72%) as a transparent solid. Data of the obtained title compound is described below.

¹H NMR (CDCl₃):

δ 8.06 (t, J=1.40 Hz, 2H), 7.90 (d, J=8.0 Hz, 2H), 7.72 (d, J=8.4 Hz, 2H), 3.55 (d, J=11.2 Hz, 4H), 1.34 (d, J=14.8 Hz, 36H).

³¹P{¹H} NMR (CDCl₃):

δ 78.1 (s).

### [Synthesis Example 5] Synthesis of Compound of Formula (6b)

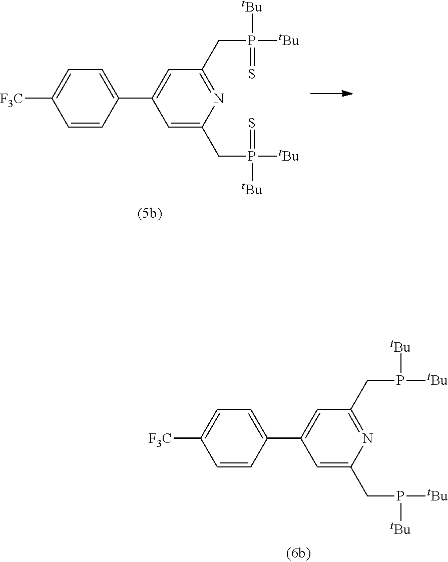 [SMILES: CC(C)(C)P(=S)(Cc1cc(-c2ccc(C(F)(F)F)cc2)cc(CP(=S)(C(C)(C)C)C(C)(C)C)n1)C(C)(C)C ; CC(C)(C)P(Cc1cc(-c2ccc(C(F)(F)F)cc2)cc(CP(C(C)(C)C)C(C)(C)C)n1)C(C)(C)C]

Synthesis was performed according to the description in Synthesis Example 2 in this specification using the compound of Formula (5b) in place of the compound of Formula (5a) used in Synthesis Example 2 to obtain a title compound (80.0 mg, 0.148 mmol, yield 74%) as a yellowish white solid. Data of the obtained title compound is described below.

¹H NMR (CDCl₃):

δ 7.57 (s, 2H), 7.29 (m, 4H), 3.21 (d, J=2.8 Hz, 4H), 1.16 (d, J=10.4 Hz, 36H).

³¹P{¹H} NMR (CDCl₃):

δ 36.22 (s).

### [Synthesis Example 6] Synthesis of Molybdenum Complex of Formula (7b)

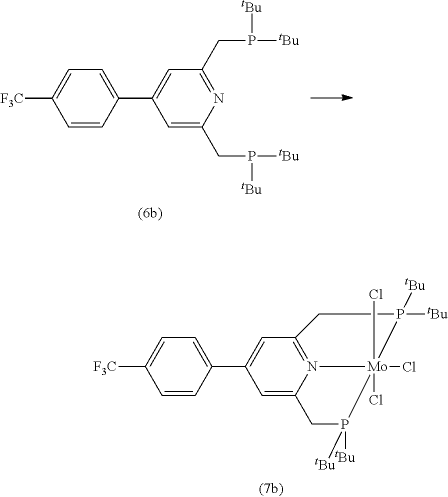

Synthesis was performed according to the description in Synthesis Example 3 in this specification using the compound represented by Formula (6b) in place of the compound represented by Formula (6a) used in Synthesis Example 3 to obtain a title compound (102 mg, 0.138 mmol, yield 92%) as a red solid. Data of the obtained title compound is described below.

Anal. Calcd. for [molybdenum complex of Formula (7b)]:

C, 45.97; H, 5.60; N, 1.73.

Found:

C, 44.61; H, 5.40; N, 1.27.

### [Synthesis Example 7] Synthesis of Compound of Formula (5c)

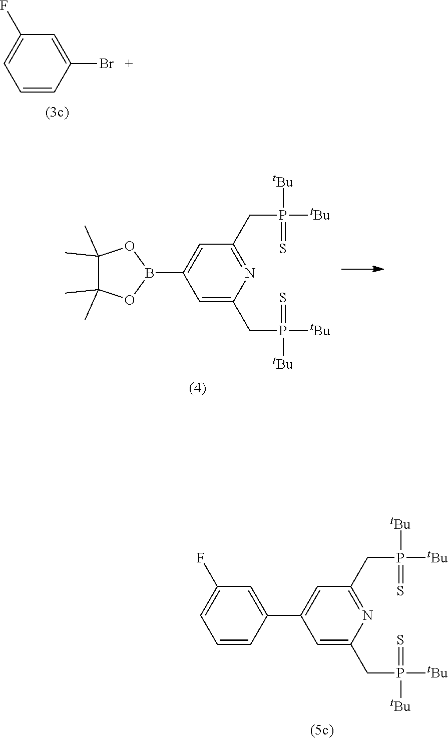 [SMILES: Fc1cccc(Br)c1 ; CC1(C)OB(c2cc(CP(=S)(C(C)(C)C)C(C)(C)C)nc(CP(=S)(C(C)(C)C)C(C)(C)C)c2)OC1(C)C ; CC(C)(C)P(=S)(Cc1cc(-c2cccc(F)c2)cc(CP(=S)(C(C)(C)C)C(C)(C)C)n1)C(C)(C)C]

Synthesis was performed according to the description in Synthesis Example 1 in this specification using 1-bromo-4-fluorobenzene of Formula (3c) (commercially available from Tokyo Chemical Industry Co., Ltd.) in place of 1-bromo-3,5-bis(trifluoromethyl)benzene of Formula (3a) used in Synthesis Example 1 to obtain a title compound (671 mg, 1.21 mmol, yield 71%) as a transparent solid. Data of the obtained title compound is described below.

¹H NMR (CDCl₃):

δ 8.00 (t, J=1.6 Hz, 2H), 7.46 (m, 3H), 7.07 (m, 1H), 3.52 (d, J=11.2 Hz, 4H), 1.33 (d, J=15.2 Hz, 36H).

³¹P{¹H} NMR (CDCl₃):

δ 78.1 (s).

### [Synthesis Example 8] Synthesis of Compound of Formula (6c)

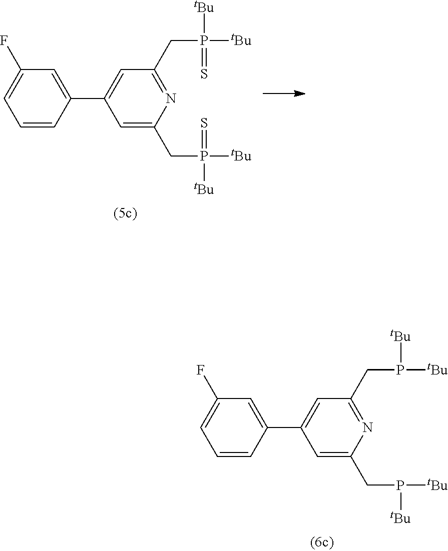 [SMILES: CC(C)(C)P(=S)(Cc1cc(-c2cccc(F)c2)cc(CP(=S)(C(C)(C)C)C(C)(C)C)n1)C(C)(C)C ; CC(C)(C)P(Cc1cc(-c2cccc(F)c2)cc(CP(C(C)(C)C)C(C)(C)C)n1)C(C)(C)C]

Synthesis was performed according to the description in Synthesis Example 2 in this specification using the compound of Formula (5c) in place of the compound of Formula (5a) used in Synthesis Example 2 to obtain a title compound (90.9 mg, 0.186 mmol, yield 93%) as a yellowish white solid. Data of the obtained title compound is described below.

¹H NMR (CDCl₃):

δ 7.59 (s, 2H), 7.33 (m, 1H), 7.25 (m, 1H), 6.86 (m, 1H), 6.75 (m, 1H), 3.18 (d, J=2.4 Hz, 4H), 1.15 (d, J=10.4 Hz, 36H).

³¹P{¹H} NMR (CDCl₃):

δ 36.01 (s).

### [Synthesis Example 9] Synthesis of Molybdenum Complex of Formula (7c)

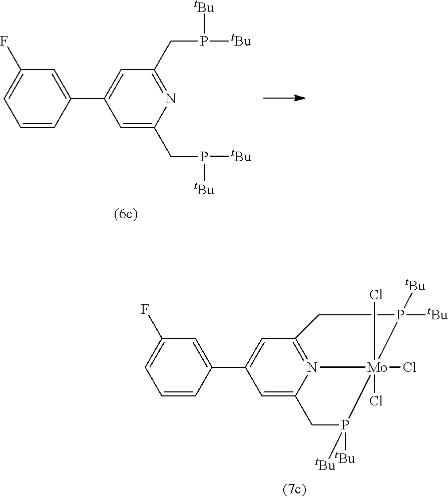

Synthesis was performed according to the description in Synthesis Example 3 in this specification using the compound of Formula (6c) in place of the compound of Formula (6a) used in Synthesis Example 3 to obtain a title compound (72.0 mg, 0.104 mmol, yield 66%) as a red solid. Data of the obtained title compound is described below.

Anal. Calcd. for [molybdenum complex of Formula (7c)]:

C, 50.34; H, 6.70; N, 2.02.

Found:

C, 51.51; H, 6.66; N, 1.80.

### [Experiment Example 1] Production of Ammonia Using Molybdenum Complex of Formula (7a)

### Molybdenum Complex of Formula (7a)

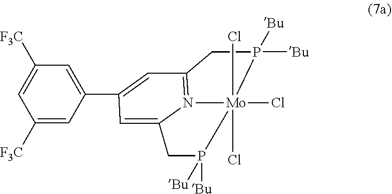

First, a solution, in which the molybdenum complex (7a) (3.2 mg, 4.0 μmol) was weighed out and dissolved in dichloromethane (10 mL), was prepared as a solution A. Next, the solution A (0.5 mL) was put into a Schrenck reaction container in a nitrogen atmosphere at atmospheric pressure, dichloromethane was then distilled off under reduced pressure, and the molybdenum complex (7a) (0.2 μmol) was added. Subsequently, diiodobis(tetrahydrofuran)samarium(II) (197 mg, 0.36 mmol) and tetrahydrofuran (5.5 mL) were then added, and a tetrahydrofuran solution (0.5 mL, 6.5 mg, 0.36 mmol as water), in which the concentration of water was adjusted to 0.72 mol/L, was added. The mixture was then stirred at a room temperature of 20° C. to 25° C. for 18 hours.

Thereafter, in order to quantify the amount of ammonia generated in this reaction, a potassium hydroxide aqueous solution (30 mass %, 5 mL) was put into the reaction container, distillation was then performed relative to the reaction container under reduced pressure, and the distillate was collected with an aqueous sulfuric acid solution (0.5 M, 10 mL). The amount of ammonia in the aqueous sulfuric acid solution was determined by the indophenol method. As a result, in a reaction time of 18 hours, 564 equivalents of ammonia were produced per amount of the molybdenum complex used as a catalyst.

### [Experiment Examples 2 to 4] Production of Ammonia Using Molybdenum Complex of Formula (7b), Formula (7c) or Formula (7d)

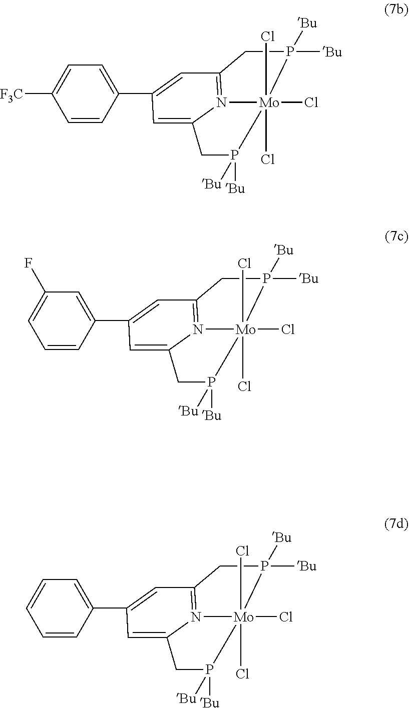

Regarding production of ammonia using a molybdenum complex shown in the molybdenum complex of Formula (7b), Formula (7c) or Formula (7d), ammonia was produced in the same experiment operation as in Experiment Example 1 except that, in place of the molybdenum complex of Formula (7a) used in Experiment Example 1, the molybdenum complex of Formula (7b) was used in Experiment Example 2, the molybdenum complex of Formula (7b) was used in Experiment Example 3, and the molybdenum complex of Formula (7d) was used in Experiment Example 4, and the amount of ammonia per amount of the molybdenum complex used as a catalyst was determined by the indophenol method. The molybdenum complex of Formula (7d) was synthesized by the method described in Non-Patent Document J. Am. Chem. Soc., 2014, vol. 136, pp. 9719-9731, Dalton Trans., 2019, vol. 48, pp. 3182-3186 with reference to the description in the synthesis example in this specification.

The results of the amount of ammonia are described below. The amount was 542 equivalents in Experiment Example 2 using the molybdenum complex of Formula (7b), 458 equivalents in Experiment Example 3 using the molybdenum complex of Formula (7c), and 449 equivalents in Experiment Example 4 using the molybdenum complex of Formula (7d).

### [Experiment Example 5] Production of Ammonia Using Molybdenum Complex of Formula (7a)

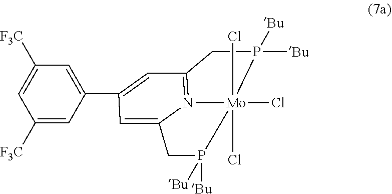

Ammonia was produced from nitrogen molecules using the molybdenum complex of Formula (7a). Ammonia was produced in the same experiment operation as in Experiment Example 1 except that the reaction time was changed from 18 hours to 1 minute. The amount of ammonia per amount of the molybdenum complex used as a catalyst for 1 minute was 126 equivalents, and the catalyst turnover frequency (turnover frequency, sometimes abbreviated as TOF), which is defined as the amount of substance converted per unit time by one catalyst molecule, was 126 (1/min).

### [Experiment Example 6] Production of Ammonia Using Molybdenum Complex of Formula (7a)

A solution A (a dichloromethane solution (10 mL) of the molybdenum complex (7a) (3.2 mg, 4.0 μmol)) processed in the same method as in Experiment Example 1 was prepared, the solution A (125 μL) was then put into a Schrenck reaction container in a nitrogen atmosphere at atmospheric pressure, dichloromethane was then distilled off under reduced pressure, and the molybdenum complex (7a) (0.05 μmol) was added. Subsequently, diiodobis(tetrahydrofuran)samarium(II) (197 mg, 0.36 mmol) and tetrahydrofuran (5.5 mL) were added, and a tetrahydrofuran solution (0.5 mL, 6.5 mg, 0.36 mmol as water), in which the concentration of water was adjusted to 0.72 mol/L, was then added. The mixture was then stirred at room temperature of 20° C. to 25° C. for 6 hours. Next, diiodobis(tetrahydrofuran)samarium(II) (197 mg, 0.36 mmol) and a tetrahydrofuran solution (0.5 mL, 6.5 mg, 0.36 mmol as water), in which the concentration of water was adjusted to 0.72 mol/L, were added, the mixture was stirred at room temperature of 20° C. to 25° C. for 22 hours, and thus ammonia was produced for a total reaction time of 28 hours.

Then, the same operation as in Experiment Example 1 was performed to determine the amount of ammonia, and it was confirmed that 3,160 equivalents of ammonia was produced per amount of the molybdenum complex used as a catalyst.

### [Experiment Example 7] Production of Ammonia Using Molybdenum Complex of Formula (7d)

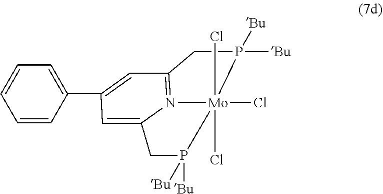

Ammonia was produced from nitrogen molecules using the molybdenum complex of Formula (7d). First, a solution, in which a molybdenum complex (7d) (2.7 mg, 4.0 μmol) was weighed out and dissolved in dichloromethane (10 mL), was prepared as a solution D. Next, the solution D (25 μL) was put into a Schrenck reaction container in a nitrogen atmosphere at atmospheric pressure, dichloromethane was then distilled off under reduced pressure, and the molybdenum complex (7d) (0.01 μmol) was added, Subsequently, diiodobis(tetrahydrofuran)samarium(II) (197 mg, 0.36 mmol) and tetrahydrofuran (2.5 mL) were added, and a tetrahydrofuran solution (0.5 mL, 6.5 mg, 0.36 mmol as water), in which the concentration of water was adjusted to 0.72 mol/L, was then added. The mixture was stirred at a room temperature of 25° C. for 48 hours to produce ammonia.

Then, the same operation as in Experiment Example 1 was performed to determine the amount of ammonia, and it was confirmed that 4,017 equivalents of ammonia was produced per amount of the molybdenum complex used as a catalyst.

### [Comparative Example 1] Production of Ammonia Using Molybdenum Complex of Formula (7e)

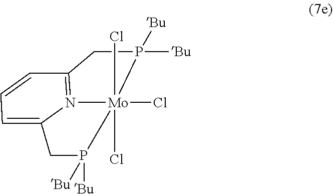

Regarding production of ammonia using the molybdenum complex of Formula (7e), ammonia was produced in the same experiment operation as in Experiment Example 1 except that the molybdenum complex of Formula (7e) was used in place of the molybdenum complex of Formula (7a) used in Experiment Example 1, and the amount of ammonia per amount of the molybdenum complex used as a catalyst was 291 equivalents.

### [Comparative Example 2] Production of Ammonia Using Molybdenum Complex of Formula (7e)

Ammonia was produced from nitrogen molecules using the molybdenum complex of Formula (7e). Ammonia was produced in the same experiment operation as in Experiment Example 1 except that the reaction time was changed from 18 hours to 60 minutes. The amount of ammonia per amount of the molybdenum complex used as a catalyst for 1 minute was 0.6 equivalents, and the TOF was 0.6 (1/min).

Based on the above results, it was found that, when an aryl group with an electron-attracting substituent was introduced to the R⁵ substituent of the molybdenum complex of Formula (2) in this specification,

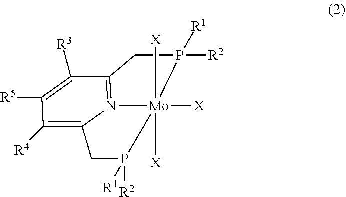

compared to Comparative Example 1 using the previously known molybdenum complex of Formula (7e),

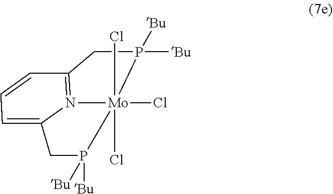

the amount of ammonia generated per amount of the molybdenum complex of Examples to 3 used could be increased by a factor of 1.6 to 1.9. In addition, in consideration of the catalyst turnover frequency, comparing Comparative Example 2 and Example 5, an improvement in which ammonia can be produced 210 times faster was found, and it was thought that this would be a clue for advancement of industrialization.

On the other hand, in comparison with the amount of ammonia generated per amount of the molybdenum complex of Formula (7d) in Example 4 and per amount of the molybdenum complex in Comparative Example 1, it was clearly understood that the amount was increased by a factor of 1.5 in Example 4.

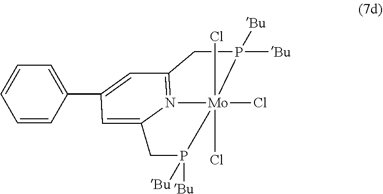

This result is a new finding for a reaction system for producing ammonia in which the reducing agent was a lanthanoid(II) metal halide and the proton source was water, and when reaction conditions as in Experiment Example 7 were investigated, an amount of 4,017 equivalents of ammonia was obtained, and thus it is thought that this finding would provide a clue for improvement toward industrialization.

### INDUSTRIAL APPLICABILITY

The present invention can be used in a method for producing ammonia.

1. A method for producing ammonia from nitrogen molecules in the presence of a reducing agent and a proton source using, as a catalyst, a molybdenum complex obtained by reacting a ligand of Formula (1) and a molybdenum compound: 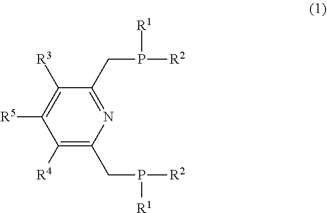
(wherein R¹ and R² are each independently C₃₋₁₀ alkyl group, R³, R⁴ and R⁵ are each independently a hydrogen atom, a fluorine atom, a trifluoromethyl group, a phenyl group, or an Ar¹ aryl group, and at least one of R³, R⁴ and R⁵ is a phenyl group or an Ar¹ aryl group).

2. A method for producing ammonia from nitrogen molecules in the presence of a reducing agent and a proton source using, as a catalyst, a molybdenum complex of Formula (2): 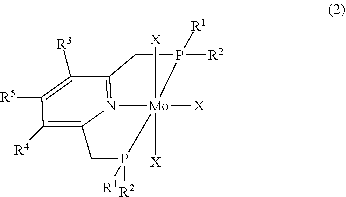
(wherein R¹, R², R³, R⁴, and R⁵ are the same as defined above, and X is a halogen atom).

3. The method for producing ammonia according to claim 1, wherein an energy level of a highest occupied orbital of the reducing agent is −5.0 eV or more, that is, an ionization potential is 5.0 eV or less.

4. The method for producing ammonia according to claim 1, wherein the reducing agent is a lanthanoid metal halide or a sandwich compound.

5. The method for producing ammonia according to claim 1, wherein the proton source is an alcohol or water.

6. A ligand of Formula (1): 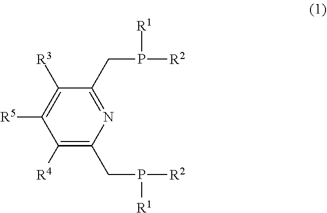
(wherein R¹ and R² are each independently C₃₋₁₀ alkyl group, R³ and R⁴ are each independently a hydrogen atom, a fluorine atom, a trifluoromethyl group, a phenyl group, or an Ar¹ aryl group, and R⁵ is an Ar¹ aryl group).

7. A molybdenum complex of Formula (2): 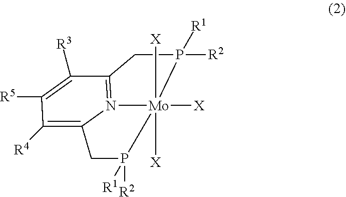
(wherein R¹ and R² are each independently C₃₋₁₀ alkyl group, R³ and R⁴ are each independently a hydrogen atom, a fluorine atom, a trifluoromethyl group, a phenyl group, or an Ar¹ aryl group, and R⁵ is an Ar¹ aryl group).
